(19) United States
(12) Patent Application Publication
(10) Pub. No.: US 2010/0192206 A1
(43) Pub. Date: Jul. 29, 2010

(54) BULLETIN BOARD SYSTEM, TERMINAL DEVICE OF BULLETIN BOARD SYSTEM, AND SERVER DEVICE OF BULLETIN BOARD SYSTEM

(76) Inventor: Kazuaki Aoyama, Tokyo (JP)

Correspondence Address: MCDERMOTT WILL & EMERY LLP, 600 13TH STREET, N.W., WASHINGTON, DC, 20005-3096, US

(21) Appl. No.: 12/617,917

(22) Filed: Nov. 13, 2009

(30) Foreign Application Priority Data
Jan. 29, 2009 (JP) 2009-018381

(51) Int. Cl. H04L 9/32; G06F 21/20; G06F 15/16; G06F 17/30

(52) U.S. Cl. 726/5; 709/203; 707/802; 707/E17.044

(57) ABSTRACT

A unique authentication ID is given to a television to automatically log in a server by using the ID. A password used for logging in the server is registered to the server from the television for each mobile phone of sub-users who share the television. A message may be input from both of the television and the mobile phone. The authentication ID, the password, a message, a user name, and an input date are stored in the server. When being accessed from the television or the mobile phone, the server generates and transmits an HTML to be displayed on the television or the mobile phone, and thus, a message is displayed in a predetermined display format for each of the television and the mobile phone.

### INCORPORATION BY REFERENCE

This application relates to and claims priority from Japanese Patent Application No. 2009-018381 filed on Jan. 29, 2009, the entire disclosure of which is incorporated herein by reference.

### BACKGROUND OF THE INVENTION

(1) Field of the Invention

The present invention relates to a bulletin board system, a terminal device of a bulletin board system, and a server device of a bulletin board system, and particularly to a bulletin board system, a terminal device of a bulletin board system, and a server device of a bulletin board system, all of which may be easily operated and enable information sharing even when users are away from each other.

(2) Description of the Related Art

In the field of an information system using mobile information terminals such as PCs (Personal Computers) and mobile phones, there has been built a mechanism of information sharing using bulletin boards of e-mails and on the Internet.

In addition, there is a trend that PC functions are incorporated into a television device so as to develop new functions related to the both. For example, Japanese Patent Application Laid-Open No. 2006-41856 discloses a technique in which a viewer associates a television program with a web page on the Internet to easily access the web page. Japanese Patent Application Laid-Open No. 2004-336479 discloses a bulletin board system into which a message can be freely input with a handwriting pen even by a person unaccustomed to operations of a PC.

### SUMMARY OF THE INVENTION

Information sharing in a general household has been conducted conventionally in a way where a note is attached to a cork board used as a bulletin board. In this method, information can be passed on to a person at home, but not to a person being away from home.

In a method of writing information onto a bulletin board on the Internet by using a PC, the information can be written or read even when a user is away from home as long as the user carries a small-sized PC. However, it takes time to start the device. Further, a user authentication operation is required, and a setting operation such as user registration when making use of a service for the first time is complicated. Thus, it is difficult to use the service for a person unaccustomed to the service. Further, a screen display unit of a PC is generally small in size and narrow in viewing angle, and is not always suitable for a case in which many people view the screen at the same time.

In a method of making use of a bulleting board of e-mails or sites of a mobile phone, a family who possesses no mobile phones cannot utilize the service, and the size of the display screen is much smaller. Thus, the mobile phone is not suitable for a case in which many people view the screen at the same time.

In consideration of these problems, an object of the present invention is to provide a bulletin board system, a terminal device of a bulletin board system, and a server device of a bulletin board system, all of which may be easily operated and enable information sharing even when users are away from each other.

In order to achieve the above-described object, the present invention provides a bulletin board system including: a network; at least one television device which is connected to the network and includes an identification ID storing unit which stores an identification ID for identifying a device, a first character information inputting unit through which a user inputs character information, a first communication processing unit which transmits the character information and the identification ID to the network and receives information from the network, and a first display unit which displays the information received from the network; at least one mobile information terminal device which is wirelessly connected to the network and includes a second character information inputting unit through which a user inputs character information, a second communication processing unit which transmits the character information to the network and receives information from the network, and a second display unit which displays the information received from the network; and a server device which is connected to the network and includes a database storing unit which stores information, an application server unit which has a function of identifying the television device which transmits the identification ID to the network to determine whether or not to connect the television device, a login function for an access from the mobile information terminal device, and a function of reading or writing the information from/to the database storing unit, a web server unit which stores an HTML to be used for video display of the information on the first display unit by the television device and an HTML to be used for video display of the information on the second display unit by the mobile information terminal device, and generates the HTML of the information read by the application server unit on the basis of the stored HTML, and a third communication processing unit which transmits the HTML of the information generated by the web server unit to the network and receives information from the network, wherein in the case where connection of the television device to the server device is authenticated by the application server unit of the server device, the information received from the network is displayed on the first display unit and the user browses or updates the information, and in the case where login of the mobile information terminal device is authenticated in the application server unit of the server device, the information received from the network is displayed on the second display unit and the user browses or updates the information.

Further, the present invention provides a terminal device of a bulletin board system for exchanging information among a plurality of users, the device being connected to a server device storing information via a network and including: an identification ID storing unit which stores an identification ID for identifying a device; a character information inputting unit through which a user inputs character information; a communication processing unit which transmits the character information and the identification ID to the network and receives information from the network; and a display unit which displays the information received from the network, wherein information related to the transmitted identification ID is received from the server device to be displayed on the display unit.

Further, the present invention provides a server device of a bulletin board system for exchanging information among a plurality of users, the device being connected to a network and including: a database storing unit which stores information; an application server unit which has a function of determining whether or not to accept an access of a device on the basis of an identification ID of the device transmitted from the device connected via the network, and a function of reading or updating the information from the database storing unit; a web server unit which stores the HTML to be used for video display of the information by the device connected via the network, and generates the HTML of the information read by the application server unit on the basis of the stored HTML; and a communication processing unit which transmits the HTML of the information generated by the web server unit to the network, and receives information from the network, wherein the HTML of the information related to the identification ID transmitted from the device connected via the network is transmitted to the network.

According to the present invention, it is possible to realize a bulletin board system, a terminal device of a bulletin board system, and a server device of a bulletin board system, all of which may be easily operated and enable information sharing even when users are away from each other, and a user-friendly bulletin board may be advantageously provided.

Further, in an embodiment of the present invention, the identification ID is given to the television device used as one of the terminal devices, so that a bulletin board system, a terminal device of a bulletin board system, and a server device of a bulletin board system, all of which supply a dedicated service in accordance with the identification ID may be advantageously provided.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a bulletin board system showing an embodiment;

FIG. 2 is a flow diagram of data of the bulletin board system showing the embodiment;

FIG. 3 is a diagram showing information accompanied by a message in the embodiment;

FIG. 4A is a diagram showing database information related to a television in the embodiment;

FIG. 4B is a diagram showing database information related to a mobile phone in the embodiment;

FIG. 4C is a diagram showing database information related to message information in the embodiment;

FIG. 5 is a block diagram of a television device showing the embodiment;

FIG. 6 is a block diagram of a mobile phone device showing the embodiment;

FIG. 7 is a block diagram of a server device showing the embodiment;

FIG. 8 is a block diagram of a web server unit showing the embodiment;

FIG. 9 is a block diagram of an application server unit showing the embodiment;

FIG. 10 is a block diagram of a database storing unit showing the embodiment;

FIG. 11 is a flow diagram of a setting method in the television device showing the embodiment;

FIG. 12 is a flow diagram of message display and editing of the television device showing the embodiment;

FIG. 13 is a flow diagram of message editing of the mobile phone device showing the embodiment;

FIG. 14 is a diagram showing a display screen of an identification ID in the embodiment;

FIG. 15 is a diagram showing a default setting screen of the television device in the embodiment;

FIG. 16 is a diagram showing a default screen of a message board of the television device in the embodiment;

FIG. 17 is a diagram showing a screen of message editing of the television device in the embodiment;

FIG. 18 is a diagram showing a screen after message editing of the television device in the embodiment;

FIG. 19 is a diagram showing a screen after message board editing of the television device in the embodiment;

FIG. 20 is a diagram showing a login screen of the mobile phone device in the embodiment;

FIG. 21 is a diagram showing a screen of the message board of the mobile phone device in the embodiment;

FIG. 22 is a diagram showing a screen of message editing of the mobile phone device in the embodiment;

FIG. 23 is a diagram showing a screen after message editing of the mobile phone device in the embodiment;

FIG. 24 is a diagram showing a screen after message board editing of the mobile phone device in the embodiment;

FIG. 25 is a diagram showing a screen of a message board of the television device after message board editing of the mobile phone device in the embodiment;

FIG. 26 is a diagram showing a screen of message editing of the mobile phone device in the embodiment;

FIG. 27 is a diagram showing a screen after message editing of the mobile phone device in another embodiment;

FIG. 28 is a diagram showing a screen after message board editing of the mobile phone device in another embodiment;

FIG. 29 is a diagram showing a screen of a message board of the television device after message board editing of the mobile phone device in another embodiment;

FIG. 30 is a block diagram of the television device showing a different embodiment;

FIG. 31 is a diagram showing a display screen of the television device in the different embodiment;

FIG. 32 is a diagram showing a display method of the television device in the different embodiment; and

FIG. 33 is a flow diagram showing a display process of the television device showing the different embodiment.

### DETAILED DESCRIPTION OF THE EMBODIMENT

Hereinafter, embodiments will be described using the drawings.

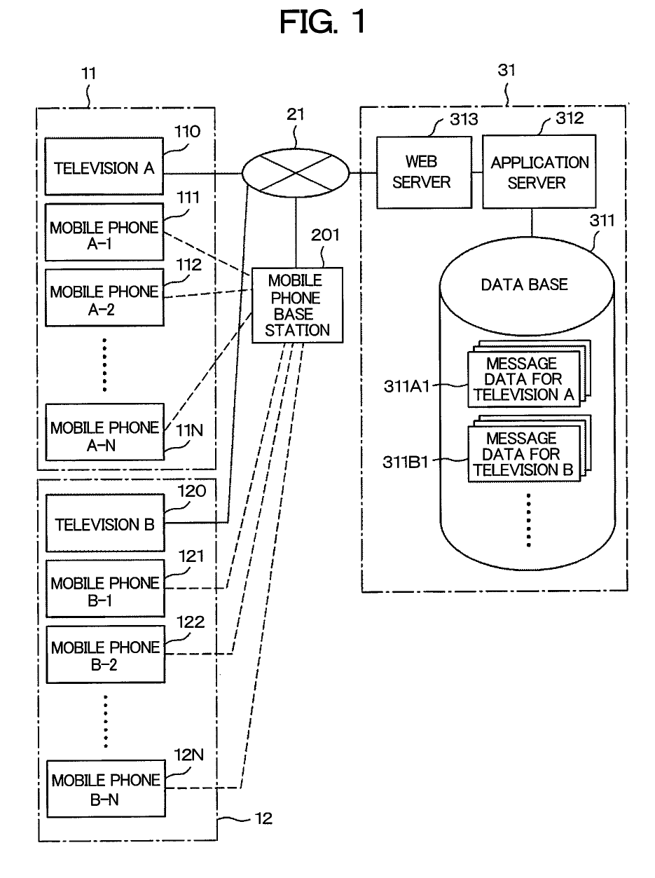

FIG. 1 is a block diagram of a bulletin board system showing an embodiment. First of all, operations thereof will be described on the basis of FIG. 1.

In FIG. 1, the reference numeral 11 denotes an information terminal group A of a household or an organization sharing a television A (110) for use, and the information terminal group A includes one or more mobile phones A-1 to A-N (111 to 11N) other than the television A (110). The reference numeral 12 denotes an information terminal group B owned by another household or another organization, and the information terminal group B includes a television B (120) and mobile phones B-1 to B-N (121 to 12N). The television A (110) and the television B (120) are connected to a server device 31 via a network 21 of the Internet (hereinafter, abbreviated as the Internet), and transmit and receive information to/from the server device 31. The mobile phones A-1 to A-N (111 to 11N) and the mobile phones B-1 to B-N (121 to 12N) are connected to the server device 31 via a mobile phone base station 201 and the Internet 21, and also transmit and receive information to/from the server device 31. It should be noted that although the reference numerals 111-11N and 121-12N denote mobile phones, this is only an example. Any mobile information terminal devices such as PDAs (Personal Digital Assistants) and mobile PCs which are carried when a parson is away from home may be used. The number of mobile phones is not limited, and each group functions with at least one mobile phone. However, it is convenient if mobile phones corresponding to the number of members of each household or each organization are provided. A plurality of television devices may be provided for one information terminal group, but there will be herein described a case in which one television is provided. The mobile phones A-1 to A-N (111 to 11N) and B-1 to B-N (121 to 12N) are wirelessly connected (shown by the dashed lines in the drawing) to the mobile phone base station 201. However, the televisions A (110) and B (120), the server device 31, and the mobile phone base station 201 may be connected (shown by the solid lines in the drawing) to the Internet 21 in a wired or wireless manner, or in the both manners. For the purpose of simplification of the drawing, only one mobile phone base station 201 is shown, which does not lead to the premise that all the illustrated mobile phones are connected to the same base station located at a short distance. As is well known, when each mobile phone is moved, it is connected to a different mobile phone base station. Thus, a plurality of base stations is actually arranged.

As will be described later, the server device 31 stores message data transmitted from the information terminal group A (11) and the information terminal group B (12) into a data base storing unit 311 via a web server unit 313 and an application server unit 312. The data base storing unit 311 is managed while being sectionalized for each information terminal group. For example, a message data storing unit 311A1 is provided for the information terminal group A (11), and a message data storing unit 311B1 is provided for the information terminal group B (12). Thereby, messages are not wrongly transmitted or received by a different household or organization. In the drawing, 311A1 and 311B1 show message data for the television A and message data for the television B, respectively. This is because the core devices in the information terminal group A (11) and the information terminal group B (12) are the television A (110) and the television B (120). For example, the message data storing unit 311A1 for the television A may be used from not only the television A (110) but also the mobile phones A-1 to A-N (111 to 11N).

Here, the bulletin board system is established in such a manner that the message data stored in the server device 31 may be written (hereinafter, referred to as produced, edited, or updated in some cases), read (hereinafter, referred to as browsed in some cases), or rewritten (hereinafter, referred to as edited or updated in some cases) from both of the television and the mobile phones. Since the mobile phone is originally for personal use, the size of an image display unit thereof is small. Thus, the mobile phone is not always suitable for being viewed by many people at the same time. However, the televisions are core devices in the embodiment, and are suitable for a case in which many people view plural pieces of message information at the same time because many televisions are now provided with 30-inch or larger image display units. One feature of the bulletin board system in the embodiment is that the television is used as a central device for message display.

It is obvious that the number of information terminal groups is not limited to two, namely 11 and 12, as shown in the drawing, but more groups may be provided, or only one group may be provided. It is conceivable that a plurality of server devices 31 may be provided without being limited to one. Further, a plurality of server devices are connected to a certain information terminal group at the same time via a different network in some cases. All the cases fall within the scope of the embodiment.

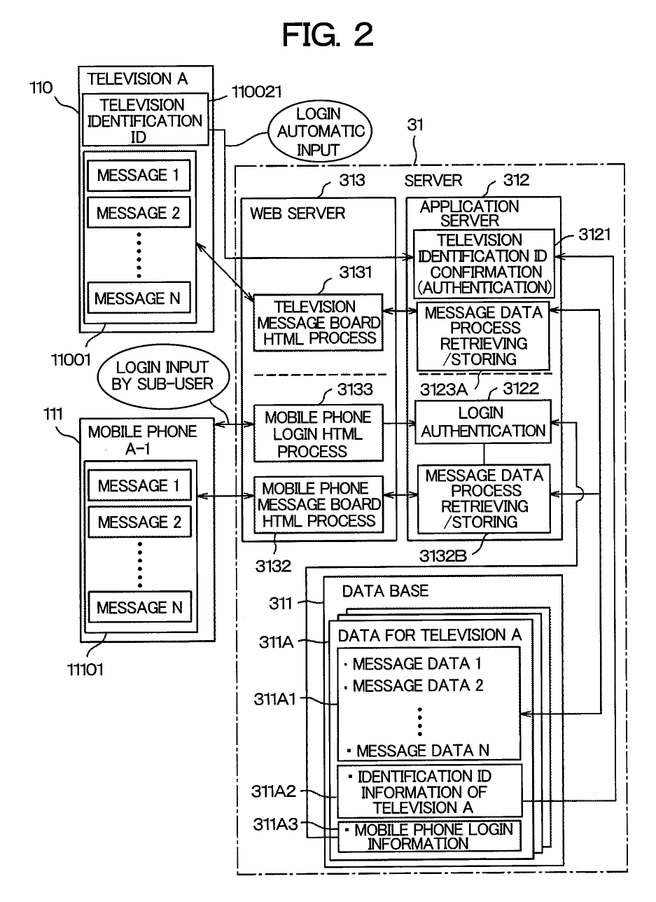

Next, the operations will be described in more detail using FIG. 2. FIG. 2 is a flow diagram of data of the bulletin board system showing the embodiment. The arrows indicate the flow of data. FIG. 2 is different from FIG. 1 in that only one television and one mobile phone are shown, the Internet 21 is not illustrated, and instead, the inside of each constituent element is shown in detail. Thus, transmission and reception of information data between one television A (110) and one mobile phone A-1 (111), and the server 31 is shown. It is obvious that this flow is similarly applied to other televisions and mobile phones.

The television A (110) has an identification ID (11002I) unique to the television stored in a storing unit such as a memory. The identification ID may be a serial number of the television, or may be set using numbers and symbols suitable for transmission and reception to/from the server device 31. As will be described later, there may be used any identification ID that may identify the television associated with the bulletin board system in the server device 31 and is unique to the television. When the television is connected to the Internet 21 for the first time after the television is manufactured or purchased, the identification ID is automatically transmitted to a television identification ID confirmation unit 3121 of the server device 31. In the case where the television is authenticated as one associated with the bulletin board system on the basis of the identification ID, a data storing unit 311A for the television A is provided in the database storing unit 311, and then, messages of the message data storing unit 311A1 to be posted on the bulletin board may be written, read, and rewritten from the television A (110) and the mobile phone A-1 (111). Further, a storing unit 311A2 for the identification ID is provided in the data storing unit 311A. It should be noted that the storing unit 311A2 for the identification ID is preliminarily provided at any place of the database storing unit 311. When the television accesses for the first time and is authenticated, the data storing unit 311A for the television A may be provided, and the storing unit 311A2 for the identification ID may be moved or copied to the data storing unit 311A.

Thereafter, in the case where the television A (110) is started, the unique identification ID is automatically transmitted to the server device 31 again, and thus, it is possible to automatically log in the server device 31 without the necessity of a particular operation. At this time, if the received identification ID corresponds to that stored in the storing unit 311A2 for the identification ID, the server device 31 specifies the data storing unit 311A for the television A. Then, a message data processing unit 3123A reads the message data stored in the data storing unit 311A, and an HTML (HyperText Markup Language) on the basis of the message data is generated by a television message board HTML processing unit 3131 to be transmitted to the television A (110). Accordingly, each message is displayed on a display unit 11001. As described above, the size of the display unit 11001 is large in general, and accordingly, a plurality of messages may be displayed and browsed by many people at the same time. Some of the messages may be updated to post new information as needed. Further, in the case where the message data are written or rewritten to the data storing unit 311A from the television A (110), an HTML after writing or rewriting transmitted from the television A (110) is processed by the television message board HTML processing unit 3131 to retrieve data for storing, and the data are stored into the data storing unit 311A via the message data processing unit 3123A.

As described above, if only storing the identification ID, it is possible to automatically log in the server from the television, and to write, read, and rewrite the message, so that a particular login operation is not necessary. Therefore, one feature of the bulletin board system is to enable to establish a user-friendly bulletin board system which may be easily used by even a person unaccustomed to operations of recent information devices.

In the case where blacklist information is stored in the database storing unit 311 and the identification ID of a device listed thereon is received, the connection may be refused. Thereby, it is possible to improve information security.

Further, as will be described later, passwords given by users to the respective mobile phones 111 to 11N belonging to the same information terminal group 11 as the television A (110) are stored into a mobile phone login information storing unit 311A3. Thereafter, the users of the mobile phones 111 to 11N may log in the server device 31 by using the passwords given to the respective mobile phones 111 to 11N and the identification ID of the television. For example, when a user logs in the serve device 31 from the mobile phone A-1 (111), the user inputs the identification ID of the television and the password into a login screen received from the mobile phone login HTML processing unit 3133, and transmits the same. The password and the identification ID of the television received and retrieved by the mobile phone login HTML processing unit 3133 are supplied to a login authentication unit 3122. The login authentication unit 3122 searches the television identification ID storing unit 311A2 storing the identification ID and the mobile phone login information storing unit 311A3 storing the password. If the mobile phone may be accordingly determined as one belonging to the information terminal group 11, a message data processing unit 3123B reads the message data stored in the data storing unit 311A, and an HTML on the basis of the message data is generated by a mobile phone message board HTML processing unit 3132 to be transmitted to the mobile phone A-1 (111). Accordingly, each message is displayed on a display unit 11101. Since the size of the display unit 11101 is relatively small as described above, the number of messages displayed at a time may be set to one or a few, and all messages may be viewed by scrolling or changing the page.

It is obvious that as similar to the case of the television A (110), writing or rewriting of the message for the data storing unit 311A may be performed using the message data processing unit 3123B and the mobile phone message board HTML processing unit 3132.

As described above, it is possible to establish the bulletin board system through which information may be shared between a person at home and a person being away from home, or between persons being away from home.

It should be noted that the television identification ID confirmation unit 3121, the login authentication unit 3122, the message data processing units 3123A and 3123B, the television message board HTML processing unit 3131, the mobile phone message board HTML processing unit 3132, and the mobile phone login HTML processing unit 3133 are executed in practice by software processing in many cases, and therefore, programs are provided and stored in the memory. However, they may be realized by hardware such as an integrated circuit serving as a processing unit for performing the respective processes.

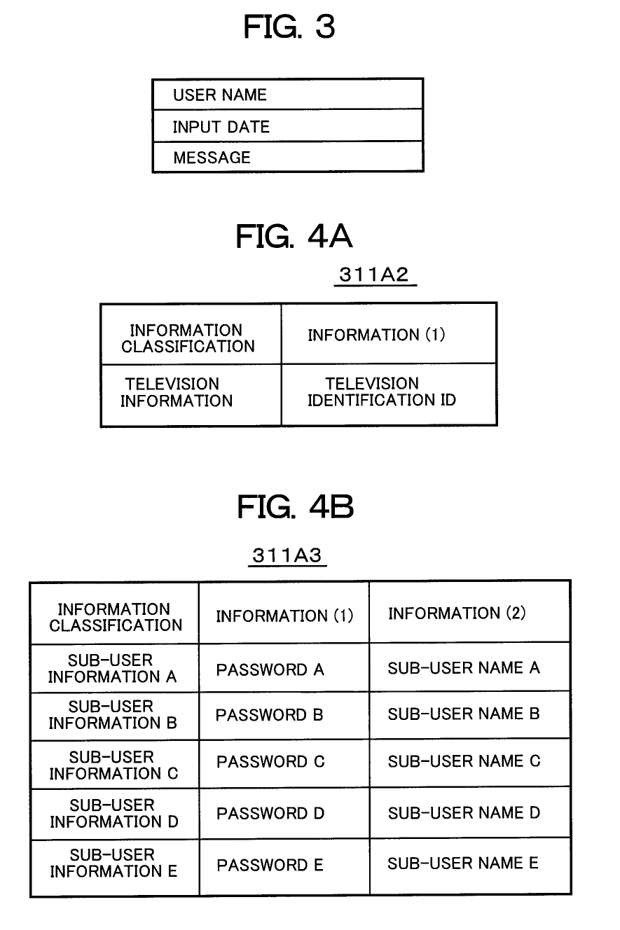

Next, an example of content of a message to be displayed will be shown on the basis of FIG. 3. FIG. 3 is a diagram showing information accompanied by a message.

As shown in the drawing, when one message is displayed, it is necessary to display at least a user name and an input date, in addition to message information itself produced by the user, judging by the characteristics of the bulletin board. Among them, the input date may be automatically registered by the server device 31. Further, the input date, together with the user name and the message information, may be received for registration by the server device 31 from the television or the mobile phone.

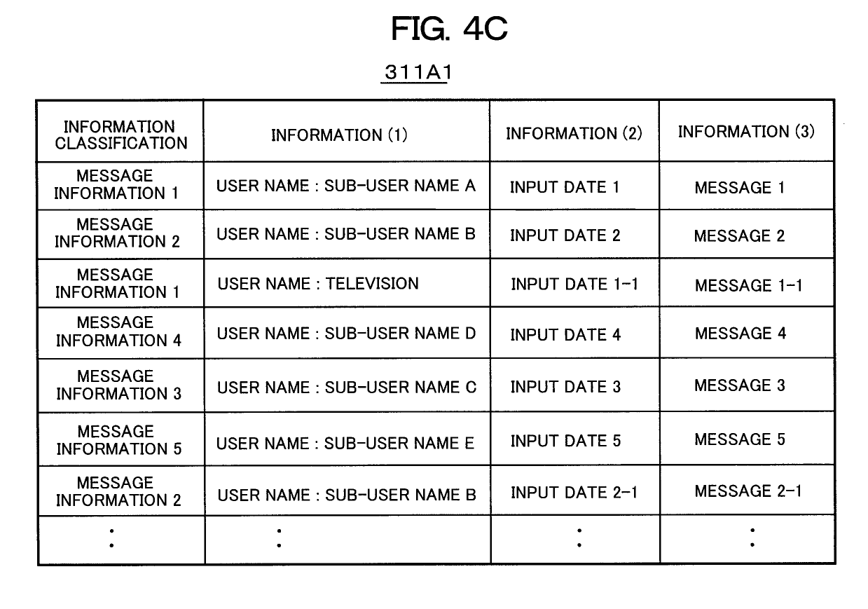

Next, the database in the server device 31 will be described using FIGS. 4A to 4C. Each of FIGS. 4A to 4C is a diagram showing database information. FIG. 4A shows database information related to the television, FIG. 4B shows database information related to the mobile phone, and FIG. 4C shows database information related to the message information. Here, content of the database information 311A related to one information terminal group 11 is shown.

The embodiment is characterized in that message information for the bulletin board is produced, browsed, or updated on the television A (110), and accordingly, a person who performs a corresponding operation with a mobile phone is referred to as a sub-user in some cases.

First of all, as shown in FIG. 4A, the television information basically requires only the identification ID (311A2). As described above, the identification ID is stored in the storing unit 311A2 for the television identification ID of the server device 31 in FIG. 2 at the time of default setting.

As shown in FIG. 4B, each piece of sub-user information using the mobile phone contains a password and a sub-user name. A plurality of passwords may be given for one identification ID of the television in the same information terminal group, and each sub-user using the mobile phone basically uses one unique password. Therefore, each row in the drawing contains one password and a sub-user name using the password which are associated with each other for management. As a sub-user name to be stored, not only “sub-user name a” as shown in the drawing but also the real name or nickname of the sub-user may be used. As will be described later, the password and the sub-user name are input from the television by the user of the television or the sub-user of the mobile phone at the time of default setting, and are stored into the mobile phone login information storing unit 311A3 of the server device 31 in FIG. 2. The password serves as the identification ID in the television when accessing the server device. There will be herein described a case in which the number of sub-users is five.

As shown in FIG. 4C, a user name, an input date, and a message itself are stored for each message information. These pieces of information are stored into the message data storing unit 311A1 of FIG. 2. It should be noted that when inputting from the mobile phone, the user name is the sub-user name of FIG. 4B. However, when inputting from the television, the user name is automatically supplied so as to simplify the operation at the time of transmission. In this case, for example, “television” is input as the user name.

A message once written may be rewritten by a person who wrote the message or other people belonging to the same information terminal group. As will be described later in detail, in the case where five message boards for displaying messages are displayed on the display unit 11001 of the television A (110), the television message board HTML processing unit 3131 allows, for example, a first message board to display information of message information 1 in FIG. 4C. Every time a new message is written, a row containing new message information is added on the upper side of FIG. 4C. As an example in FIG. 4C, two rows of message information are present for messages displayed on each of the first and second message boards. The information that is given the * mark in FIG. 4C is the latest information related to its message board. In the case where the stored message information is transmitted to the television and the mobile phone, the server device reads the latest information for transmission.

As an explanation about the message information 1 in FIG. 4C, a message 1-1 written at an input date 1-1 from the television is then rewritten into a message 1 at an input date 1 from the mobile phone used by the sub-user name a. Therefore, after rewriting, not only the message itself, but also the user name and the input date after rewriting are displayed on the display units 11001 and 11101. Further, for message information 2, a sub-user name b who wrote first rewrites the message by himself/herself. The latest information is displayed as described above, thus enabling information exchange through the bulleting board system. It should be noted that messages 1-1 and 2-1 each of which is not given the * mark in FIG. 4C become past logs. If it is not necessary to store the messages, they may be deleted at the discretion of the server device 31.

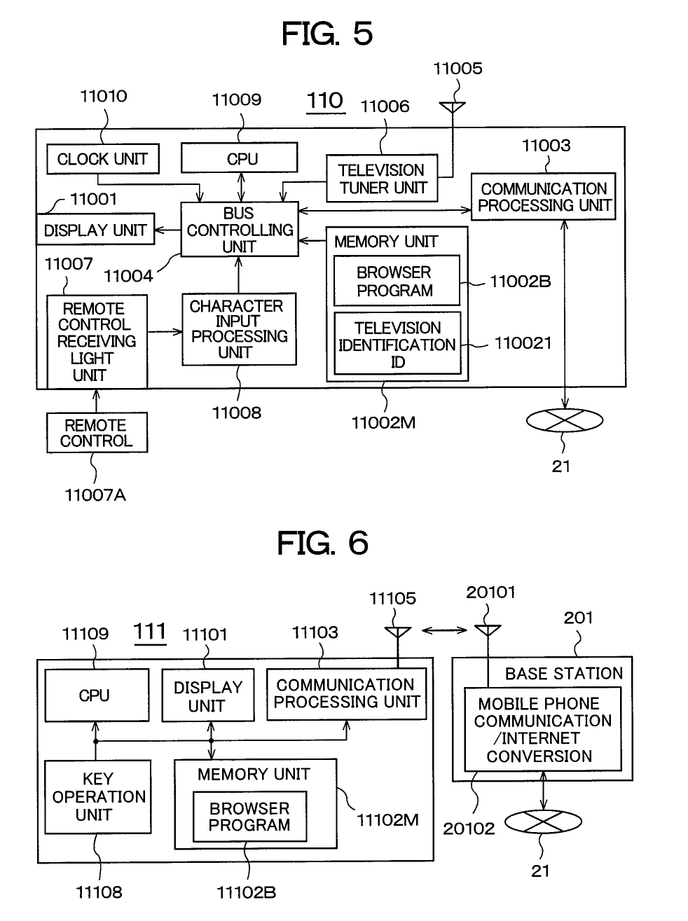

Next, a basic configuration of the television device 110 will be described using FIG. 5. FIG. 5 is a block diagram of the television device. The display unit 11001 and the identification ID 11002I correspond to those shown in FIG. 2, and thus, are given the same reference numerals.

First of all, a reception route of television broadcast will be described. A signal of a channel which a user wishes to receive is selected by a television tuner 11006 from airwaves received by an antenna 11005, and is converted, for video display, into a signal such as an RGB signal suitable for display on the display unit 11001 via a bus controlling unit 11004. It is obvious that the video may be displayed by receiving not the airwaves that are propagated in a wireless manner, but cable television broadcast that is propagated through a cable. A CPU (Central Processing Unit) 11009 controls the whole operation of signal processing using the bus controlling unit 11004.

Next, transmission and reception routes using the Internet 21 will be described. A communication processing unit 11003 transmits and receives information to/from the Internet 21. It is possible to receive IPTV (Internet Protocol Television) through the route. However, there will be herein described matters related to the bulletin board.

As described above, in the case where the television A (110) is connected to the network for the first time, or the television A (110) is started thereafter, the identification ID (11002I) included in a memory unit 11002M is transmitted to the server device 31 via the Internet 21. The URL (Uniform Resource Locator) of the destination server device 31 is preliminarily stored in the memory unit 11002M. Further, in the case where message information is received from the server device 31, the communication processing unit 11003 similarly supplies the received message information to the bus controlling unit 11004. Furthermore, the information is supplied by a browser program 11002B included in the memory unit 11002M to the display unit 11101 for display on the basis of an HTML transmitted from the server device. A user may produce, browse, or update the message information. In the case of producing or updating a message, character information for producing a message or updating a message generated, for example, by operating operation buttons of a remote control 11007A by a user is input to a character input processing unit 11008 from a remote control light receiving unit 11007, and the characters are input, by using a browser program 11002B through the bus controlling unit 11004, to the display screen on the basis of the HTML transmitted from the server device 31. Then, the characters are transmitted to the server device 31 via the communication processing unit 11003 and the Internet 21.

It should be noted that a date when the message was produced or updated may be supplied by using time information from a clock unit 11010.

Next, a basic configuration of the mobile phone 111 will be described using FIG. 6. FIG. 6 is a block diagram of the mobile phone.

The communication processing unit 11103 transmits and receives information to/from the Internet 21 via an antenna 11105 and the mobile phone base station 201. A route between the mobile phone 111 and the mobile phone base station 201 may be the same as a wireless communication route used for a normal call or e-mail transmission and reception. The mobile phone base station 201 transmits information received by an antenna 20101 to the Internet 21 via a mobile phone communication/Internet conversion unit 20102. Further, the communication processing unit 11103 receives information via the Internet 21. If the information is in an HTML format, the message is displayed in a predetermined format, to be described later, in accordance with the received HTML on the basis of a browser program 11102B included in the memory unit 11102M, and the message is supplied to the display unit 11101 for display. A user may produce, browse, or update the message information. In the case of producing or updating a message, character information for producing a message or updating a message generated, for example, by operating operation buttons of a key operation unit 11108 by the sub-user is input, and is transmitted to the server device 31 via the communication processing unit 11103, the antenna 11105, and the mobile phone base station 201, and the Internet 21. An example of a method for obtaining the URL of the destination server device will be described later. A controlling unit 11109 including a CPU controls the whole operation of the constituent elements. When accessing the server device 31, a password is input from the key operation unit 11108 including push buttons of an operation panel to the display screen on the basis of the HTML transmitted from the server device to log in the server device 31. When receiving message information, the message information is displayed on the display unit 11101 on the basis of the HTML transmitted from the server device 31. Further, in the case of producing or updating a message, a sub-user inputs characters from the key operation unit 11108, and inputs the characters to the display screen by using the browser program 11102B on the basis of the HTML transmitted from the server device 31. Then, the characters are transmitted to the server device 31.

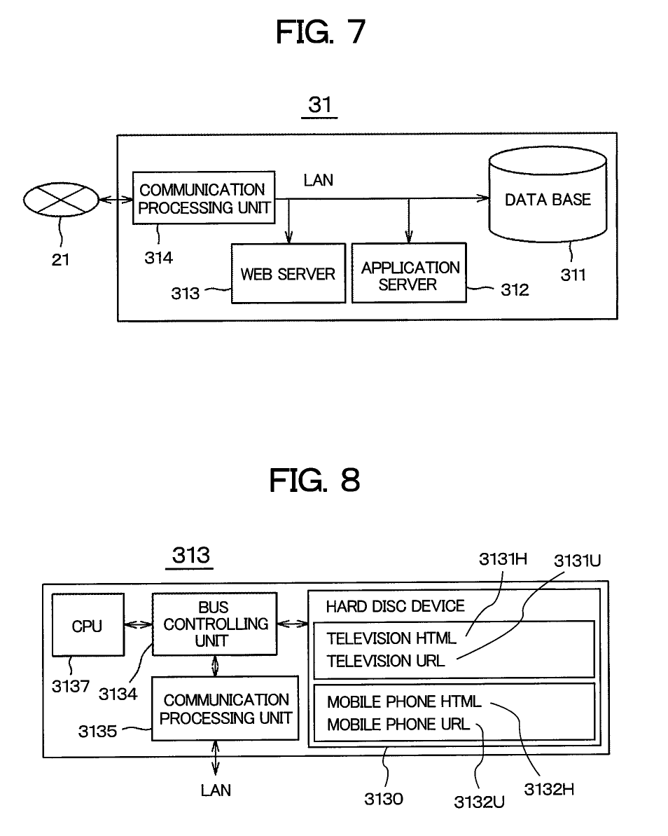

Next, a basic configuration of the server device 31 will be described using FIG. 7. FIG. 7 is a block diagram of the server device. The database storing unit 311, the application server unit 312, and the web server unit 313 correspond to those shown in FIG. 2, and thus, are given the same reference numerals.

The communication processing unit 314 transmits and receives information via the Internet 21. The database storing unit 311, the application server unit 312, and the web server unit 312 are connected to each other via a LAN (Local Access Network). When receiving the identification ID from the television A (110), the application server unit 312 refers to the database storing unit 311 to determine whether or not to connect the television. When the identification ID is received for the first time to establish connection, a portion where a new message group is stored is set on the database 311. When the previously-received identification ID is received again to establish connection, for example, the message group 311A is selected on the basis of the identification ID. In addition, the application server unit 312 has a login function using a password when being accessed from the mobile phone 111. Further, in accordance with a request from a user of the television A (110) or the mobile phone 111, the application server unit 312 newly writes the message information into the database storing unit 311, or reads the same for rewriting. When transmitting and receiving the message information to/from the Internet 21, the web server unit 313 performs a process related to the HTML used for display in the destination device as described above.

Next, a basic configuration of the web server unit 313 will be described using FIG. 8. FIG. 8 is a block diagram of the web server unit. A hard disk device 3130 stores therein a television HTML (3131H) used for the television message board HTML processing unit 3131 and a mobile phone HTML (3132H) used for the mobile phone message board HTML processing unit 3132. Further, a television URL (3131U) and a mobile phone URL (3132U) are stored, and FIG. 8 shows an example in which transmission and reception of information using URLs is enabled. These URLs may be stored when being accessed from each television or each mobile phone for the first time. A CPU 3137 controls the whole operation of signal processing by using a bus controlling unit 3134, and also performs the process related to the HTML as described above. The all units are connected to the LAN via a communication processing unit 3135.

It should be noted that the television HTML (3131H) and the mobile phone HTML (3132H) are configured by software in many cases. These units are provided for the web server 313, so that the display screen of the bulletin board for the television or the mobile phone is generated. Therefore, it is not necessary for the television or the mobile phone to be equipped with constituent elements for generating the display screen, which advantageously prevents the costs of these terminal devices from increasing due to the functions of the bulletin board.

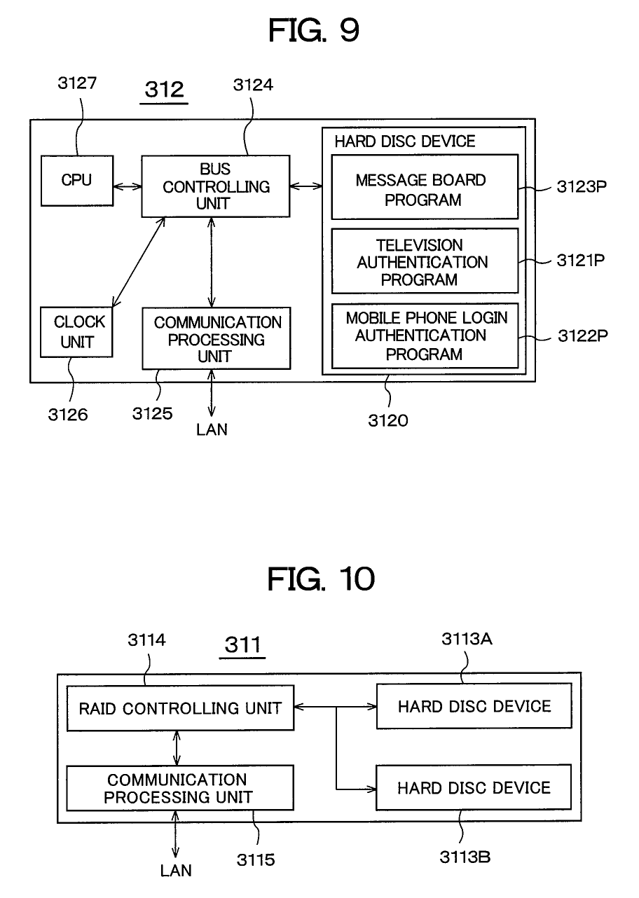

Next, a basic configuration of the application server unit 312 will be described using FIG. 9. FIG. 9 is a block diagram of the application server unit. A hard disk device 3120 stores therein a message board program 3123P for retrieving or storing message data, which are transmitted or received by the message data processing units 3123A and 3123B, from/into the database storing unit 311, a television authentication program 3121P for allowing the television identification ID confirmation unit 3121 to perform authentication of the television, and a mobile phone login authentication program 3122P for allowing the login authentication unit 3122 to perform login authentication of the mobile phone. A CPU 3127 controls the whole operation of signal processing by using a bus controlling unit 3124, and performs authentication, or retrieves or stores the message data as described above. The all units are connected to the LAN via the communication processing unit 3125. It should be noted that in order to automatically store the input date of FIG. 4C, a clock unit 3126 is provided.

Next, a basic configuration of the database storing unit 311 will be described using FIG. 10. FIG. 10 is a block diagram of the database storing unit. Hard disk devices 3113A and 3113B are provided to store message data. However, this is only an example, and the number of hard disk devices is not limited. These hard disk devices are controlled by an RAID (Redundant Arrays of Independent Disks) controlling unit 3114 so as to function as one virtual large-capacity memory, and write and read the message data. The all units are connected to the LAN via a communication processing unit 3115.

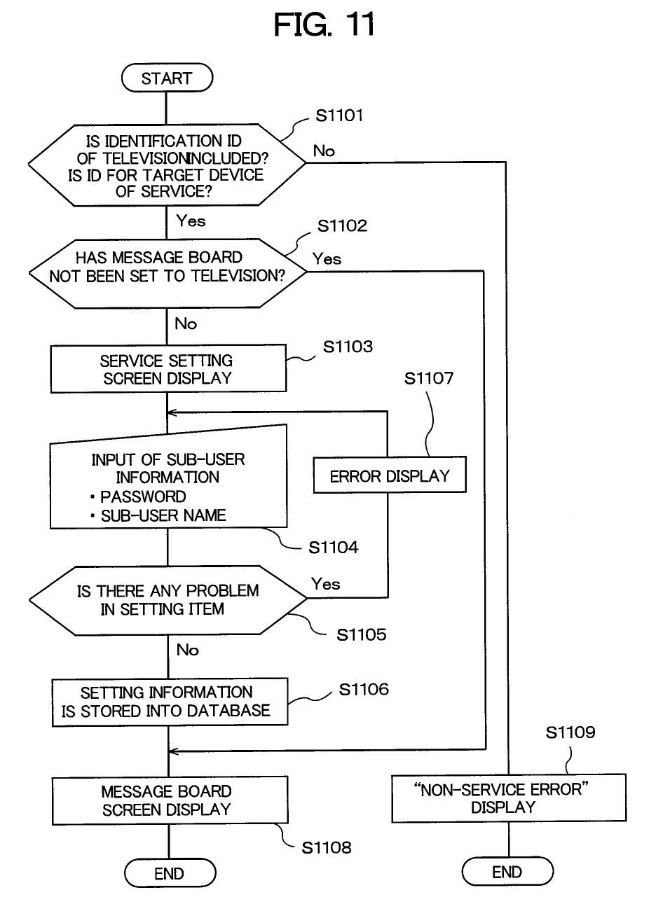

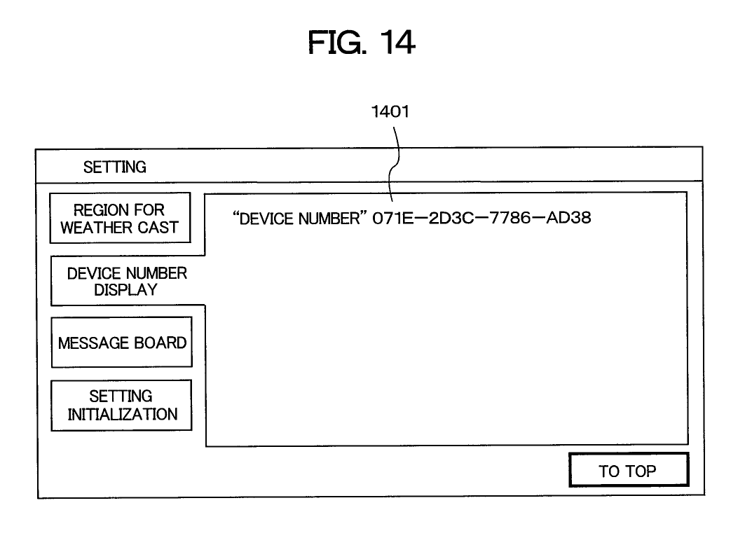

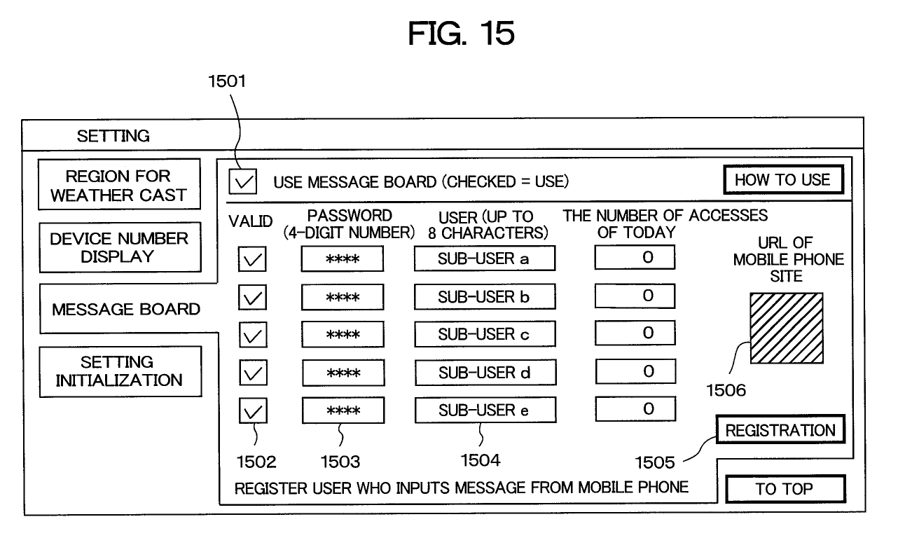

Next, an authentication method of the television in the server device and a setting method in the television will be described in detail using FIGS. 11, 14, and 15. FIG. 11 is a flow diagram of a setting method in the television device. FIG. 14 is a diagram showing a display screen for the identification ID. FIG. 15 is a diagram showing a setting screen of the television device.

First of all, the television A (110) of FIG. 5 is connected to the Internet 21 from the browser program 11002B via the communication processing unit 11003, and is connected to the web server unit 313 of the server device 31 of FIG. 7. When being connected to the web server unit 313, the browser program 11002B transmits the identification ID (11002I) of the television to the server device 31. The web server unit 313 transmits the identification ID to the television authentication program 3121P (FIG. 9) of the application server unit 312.

The television authentication program 3121P determines in Step S1101 of FIG. 11 whether or not the identification ID is included in the received data and whether or not the identification ID included is already registered as the identification ID of the television for the bulletin board service in the database storing unit 311. In the case where the identification ID is not included and the identification ID is not registered as a target television for the bulletin board service (No in the flow diagram), indication for indicating “non-service” is generated by the television HTML (3131H) of FIG. 8 in Step S1109 to be transmitted to the television A (110) for display on the display unit 11001, and the flow is completed.

In the case where the result of determination in Step S1101 shows that the identification ID is included in the received data and is registered as one for the television for the bulletin board service (Yes in the flow diagram), the television is authenticated as a target television for the bulletin board service, and the television authentication program 3121P of the application server unit 312 permits the web server unit 313 to display the bulletin board service on the television A (110). It should be noted that in the case where the device number of the television is used as the identification ID used for authentication, the device number of the television may be displayed on the display unit of the television as shown in FIG. 14.

As described above, the identification ID is automatically transmitted to the server device without any complicated operation by a user. Accordingly, even a user unaccustomed to using the device may easily use the bulletin board system.

Next, it is determined in Step S1102 whether or not the message board has been set on the television, which transmitted the identification ID, due to the first access to the server device 31. This determination may be easily made in the server device 31 on the basis of the status of the data storing unit 311 for the television A shown in FIG. 2.

In the case where the result of determination in Step S1102 shows that the message board has not been set (No in the flow diagram), the web server unit 313 reads a message board setting program from the message board program 3123P of the application server unit 312 in Step S1103, and allows the television HTML (3131H) to generate the HTML, on the basis of the program to be transmitted to the browse program 11002B of the television A (110).

An example of a message board service setting screen thus displayed on the display unit 11001 of the television A (110) in Step S1103 is shown in FIG. 15. A check box 1501 for selecting valid/invalid of the message board service is provided on the message board service setting screen. When a user of the television makes use of the service, the check box is checked as shown in the drawing. In Step S1104, predetermined items are input to a valid/invalid check box 1502, a password input box 1503, and a sub-user name input box 1504 for each sub-user who accesses from the mobile phone. For the password, alphameric characters may be used, or only alphabetical characters or numeral characters may be used. However, it is undesirable to be viewed by the people around, and accordingly, asterisks the number of which corresponds to that of characters may be displayed as shown in the drawing. To avoid complication of the drawing, each of the reference numerals 1502 to 1504 is given to only one of the respective constituent elements. It is obvious that the number of sub-users is not limited to up to 5 as shown in the drawing. In addition, the predetermined items may be input from the television by using the remote control 11007A of FIG. 5, or may be input on a touch panel by displaying a key board on the display unit 11001. As described above, some methods may be applied. Further, it is conceivable that the items are input to only the check boxes 1501, 1502, and 1503, and a sub-user name given by the server device 31 is displayed, so that the sub-user uses the name as it is.

After completion of input, a registration button 1505 on the screen is clicked. Accordingly, the set content is transmitted to the message board program 3123P of the application server unit 312 to confirm whether or not there is any problem in the items such as no description or violation against the limitation of the number of characters in Step S1105. If there is no problem (No in the flow diagram), a new data storing unit 311A is prepared in Step S1106, and a message data storing unit 311A1 is provided therein. Further, the mobile phone login information storing unit 311A3 is provided to store therein the sub-user name and the password obtained in Step S1104, and the television identification ID storing unit 311A2 is provided to store the identification ID. It should be noted that the data storing unit 311A is provided while including only the television identification ID storing unit 311A2 when the television A (110) is authenticated in Step S1101 (Yes in the flow diagram), and the identification ID may be stored therein. Further, the message data storing unit 311A1 and the mobile phone login information storing unit 311A3 may be additionally provided in the same data storing unit 311A in Step S1106. If there is a problem in Step S1105 (Yes in the flow diagram), an error is transmitted to the web server unit 313, and the television HTML (3131H) transmits the error to the browser program 11002B of the television. After the browser program 11002B displays the error on the display unit 11001 in Step S1107, the flow returns to Step S1104 to prompt to correctly input again.

Thereafter, while including the case where it is determined in Step S1102 that the message board is already set, the screen of the message board is displayed on the display unit 11001 of the television in Step S1108, and the user may edit the screen.

It should be noted that a portion shown by the diagonal lines in FIG. 15 denotes a two-dimensional bar-code display section 1506, and the usage thereof will be described later.

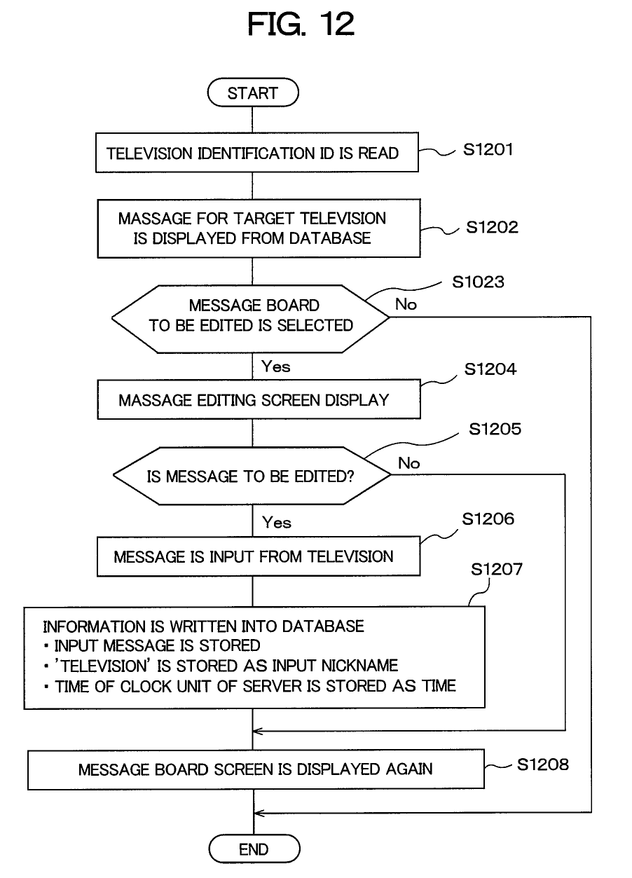

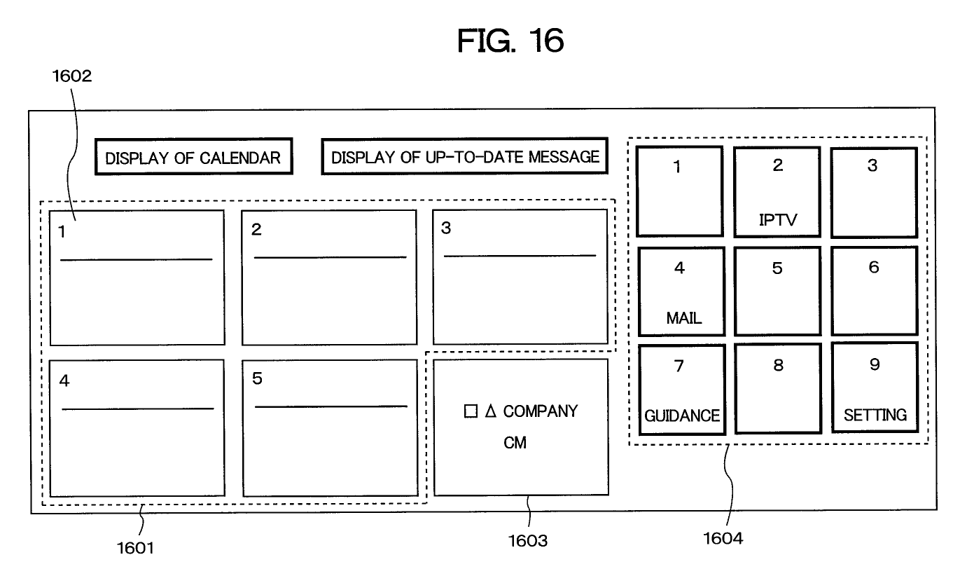

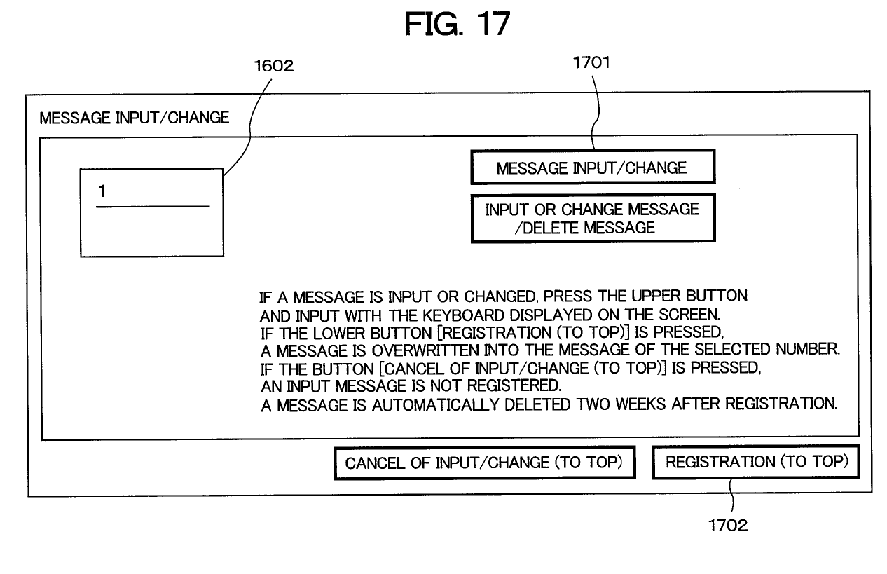

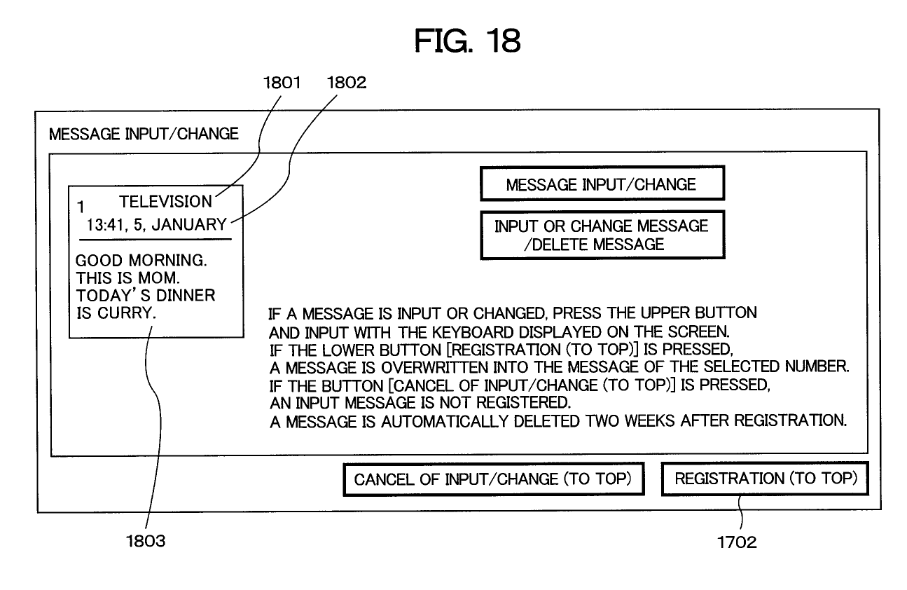

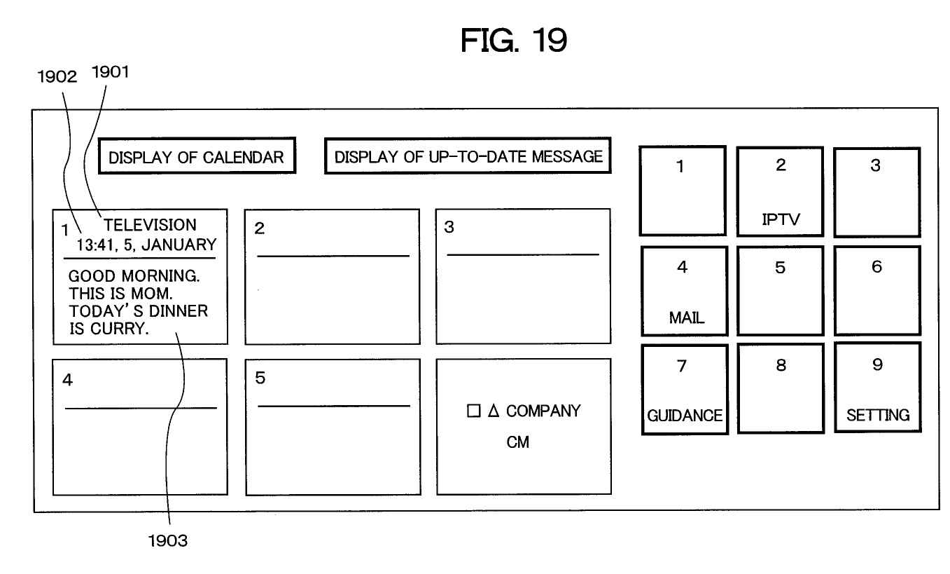

Next, a display method and an editing method of a screen of the message board will be described using FIG. 12 and FIGS. 16 to 19. FIG. 12 is a flow diagram of message display and editing of the television device, FIG. 16 is a diagram showing a default screen of the message board of the television device, FIG. 17 is a diagram showing a screen of message editing of the television device, FIG. 18 is a diagram showing a screen after message editing of the television device, and FIG. 19 is a diagram showing a screen after message board editing of the television device.

FIG. 12 shows a case in which the message board is already set for the television to be used. When the message board is unset, the flow proceeds to that shown FIG. 11. However, in this case, after reaching Step S1108 of FIG. 11, flows subsequent to Step S1203 of FIG. 12 are performed.

In Step S1201, when a power source of the television A (110) is turned on and the television identification ID is transmitted to the server device 31, the television authentication program 3121P of the application server unit 312 of the server device 31 reads the television identification ID received from the television A (110). In Step S1202, the message data processing unit 3123A reads data of the data storing unit 311A for the television A stored in the television identification information storing unit 311A2 from the database storing unit 311 on the basis of the identification ID. On the basis of the data, the web server unit 313 generates the HTML on the basis of the television HTML (3131H) to be transmitted to the browser program 11002B of the television A (110). Accordingly, the message board generated by the television HTML (3131H) is displayed on the display unit 11001 of the television A (110).

Next, a display method of message data for the message board will be described. First of all, FIG. 16 shows an example of a display screen on the display unit 11001 at a stage where no message is written on the message board. An example in which there are five message boards in a region 1601 shown by the dashed line in the drawing is shown, and a first message board on which a message is about to be written is shown by the reference numeral 1602. It is obvious that the number of message boards is not limited to five, and as a message board on which a message is written for the first time, for example, a second or third message board may be selected. As will be described later, a user name, an input date, and a message are displayed on each message board. As described above, these pieces of information are displayed on the display unit 11001 in such a manner that the television HTML (3131H) of the web server unit 313 retrieves the data 311A1 of the target television from the database 311 via the message board program 3123P of the application server unit 312, and the television HTML is generated on the basis of the user name, input date, and message included in the data to be transmitted to the television A (110).

It should be noted that the reference numeral 1603 denotes a commercial display section for a television manufacturing company or a software supplier, but this is only an example, and the commercial display section may not be provided. Further, some additional functions may be selected by a user from push buttons in an application key region 1604. In the case where a mail in the drawing is selected, a received mail may be displayed on the display section 1603. As similar to the above, in the case where a service different from the bulletin board system is received from a server other than the server device 31, information of the service may be displayed on the display section 1603.

Next, an editing method of the message data from the television will be described in detail.

In the case where a user does not select any one of the message boards displayed within a predetermined period in Step S1203 (No in the flow diagram), the flow is completed without performing any other steps. In the case where the user selects any one of the message boards (Yes in the flow diagram), a screen for message editing is displayed in Step S1204. It should be noted that as a selection method of the message board, the user may select, for example, the first message board 1602 of FIG. 16 with the remote control 11007A.

An example of a screen displayed on the display unit 11001 in Step S1204 is shown in FIG. 17. This is an example in which the first message board 1602 is selected. This example is also generated on the basis of the television HTML (3131H) of the web server unit 313, and is transmitted to the television. On the screen shown in FIG. 17, for example, an instruction button 1701 indicating “input or change message” is displayed. In the case where the user does not push the instruction button 1701 for a predetermined period in Step S1205 (No in the flow diagram), it is determined that the message is not to be edited, and the message board as shown in FIG. 16 is displayed again in Step S1208.

In the case where the user pushes the instruction button 1701 (Yes in Step S1205), for example, a key board is displayed on the display screen in Step S1206, and the user inputs a message from the television for the message board 1602 by using the key board. An example of a display screen after inputting a message is shown in FIG. 18. As an example, a name “television”, a current time, and the message written into the region 1602 are displayed at a display section 1801 of the user, a display section 1802 of a date, and a message board 1803, respectively. It is possible to automatically input the user name and the date without any complicated operation by a user. When the user pushes, for example, an instruction button 1702 indicating “registration (to top)” after inputting, the input message is fixed.

The fixed message is transmitted to the message board program 3123P of the application server unit 312 in Step S1207, and is stored into a data storing area for the target television of the database 311 on the basis of the television identification ID. For example, television information form the television A (110) is stored into the message data storing unit 311A1 of the data storing unit 311A for the television A. At this time, if the message written into the first message board 1602 among five message boards in FIG. 16 is stored into a message data 1 of the message data storing unit 311A1 of FIG. 2, a display position when being displayed on the television A (110) may be fixed. In addition, together with the message data, the date when the message was written is retrieved from the clock unit 3126 of the application server unit 312 to be stored into the message data 1 of the storing unit 311A1, and, for example, “television” is stored into the message data 1 of the storing unit 311A1 as the user name.

In Step S1208 after storage, the television message board HTML (3131H) retrieves the date when the message data were written and the user name from the message data storing unit 311A1 via the message data processing unit 3123A to generate the HTML, and transmits the same to the television A (110). This is displayed on the display unit 11001 of the television A (110). An example of a display screen at this time is shown in FIG. 19. On the message board among five message boards, in addition to an edited message 1903, the name “television” and the date when the message was written are displayed at a display section 1901 of a user name and a display section 1902 of a date, respectively. It should be noted that the television message board HTML processing unit 3131 generates an HTML for the data described in the message data 1 of the message data storing unit 311A1 so as to be displayed on the first message board given the first number of FIG. 19. Accordingly, an area where a particular message is displayed is not changed in every access. Further, a plurality of time-series messages may be displayed.

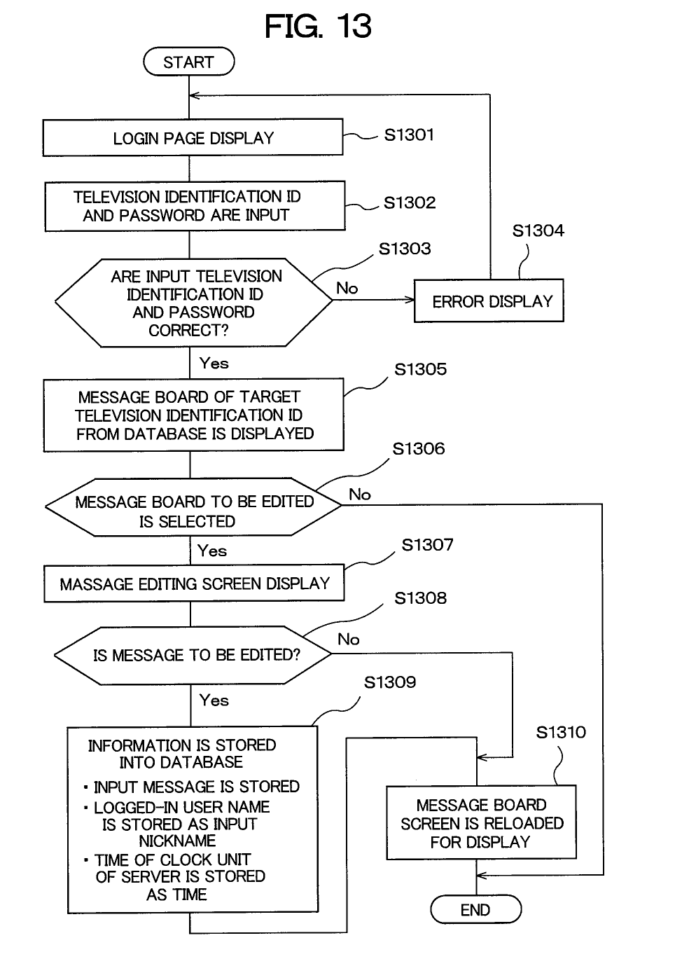

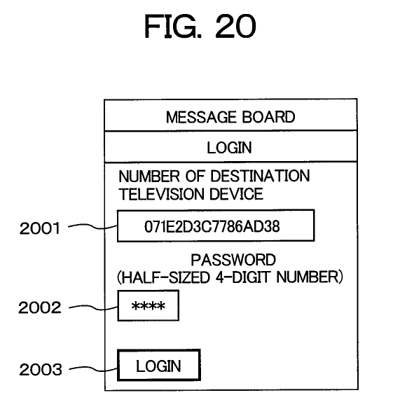

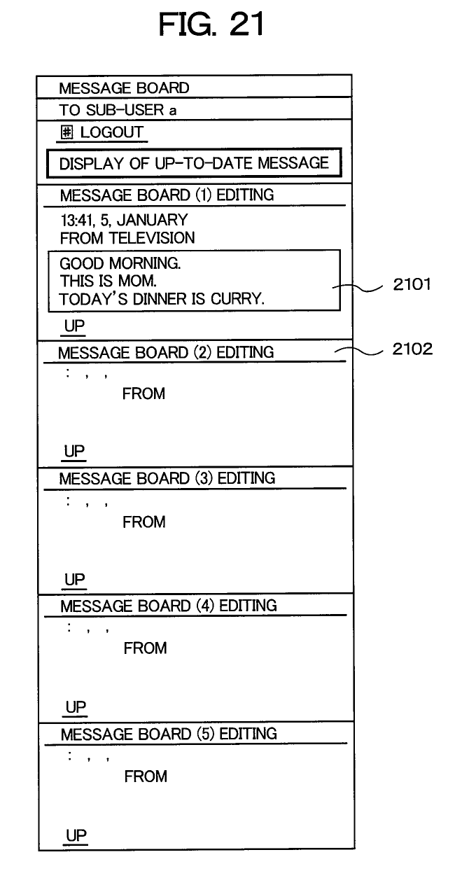

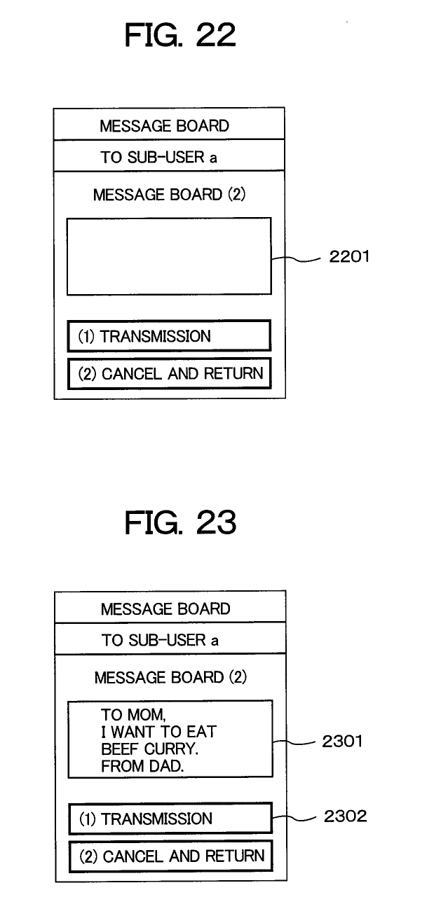

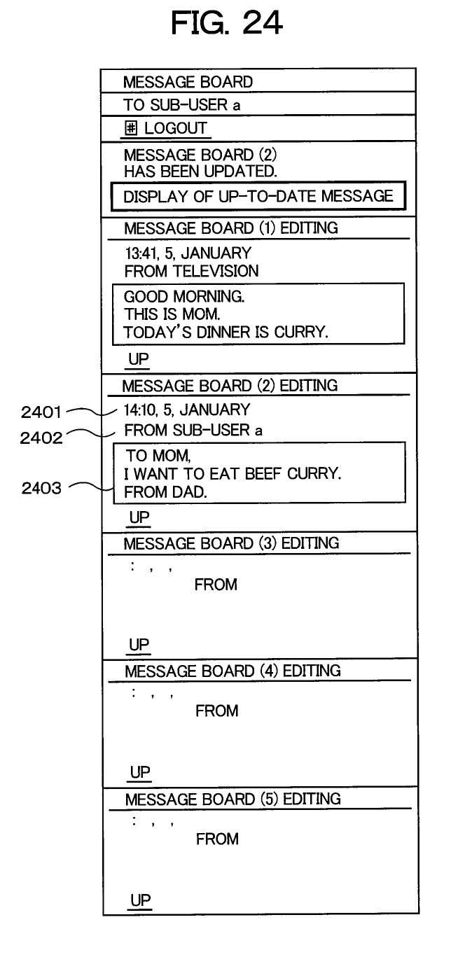

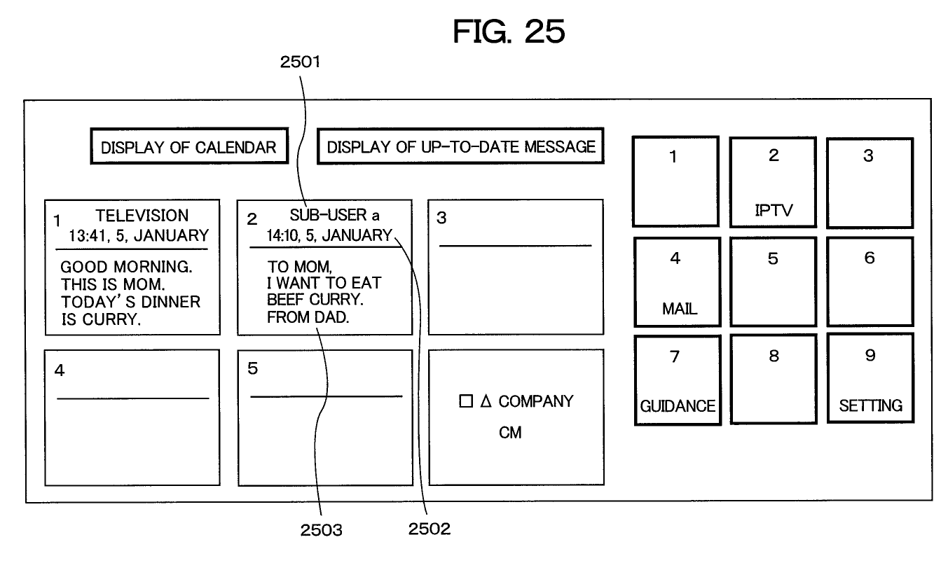

Next, a login authentication method and an editing method of a message from the mobile phone will be described in detail using FIG. 13 and FIGS. 20 to 25. FIG. 13 is a flow diagram of message editing of the mobile phone device. FIG. 20 is a diagram showing a login screen of the mobile phone device. FIG. 21 is a diagram showing a screen of the message board of the mobile phone. FIG. 22 is a diagram showing a screen of message editing of the mobile phone device. FIG. 23 is a diagram showing a screen after message editing of the mobile phone device. FIG. 24 is a diagram showing a screen after message board editing of the mobile phone device. FIG. 25 is a diagram showing a screen of the message board of the television device after message board editing of the mobile phone device.

First of all, a login authentication method from the mobile phone will be described. The mobile phone 111 of FIG. 6 is connected to the server device 31 from the browser program 11102B of the mobile phone via the base station 201 and the Internet 21.

An example of a method in which the mobile phone 111 obtains the URL of the server device 31 will be described. On the setting screen of the television device in FIG. 15, the two-dimensional bar-code for the URL of a mobile phone site in the server device 31 is displayed at the two-dimensional bar-code display section 1506 shown by the portion of the diagonal lines in the drawing. The bar-code is read by a video camera mounted in the mobile phone 111 to easily obtain the URL, and the URL may be stored into the memory unit 11102M of FIG. 6. It is obvious that a method of manually inputting the URL with the key operation unit 11108 may be used.

In Step S1301 of FIG. 13, the HTML generated by the mobile phone HTML (3132H) of the web server unit 313 is transmitted to the mobile phone 111 to be displayed on the display unit 11101. An example of display at this time is shown FIG. 20.

A sub-user of the bulletin board system which is a user of the mobile phone inputs the identification ID of the television A (110) and the password of the sub-user set in FIG. 15 into a display window 2001 and a display window 2002, respectively, by using the key operation unit 11108 of the mobile phone 111 in Step S1302. Then, the sub-user pushes and fixes a push button 2003 indicating, for example, “login” for transmission to the server device 31 via the base station 201. At this time, the mobile phone HTML (3132H) of the web server unit 313 transmits to the application server unit 312 the television identification ID and the password of the sub-user which are authentication information.

It should be noted that if it is difficult to manually input the television identification ID, there may be used a method in which the two-dimensional bar-code shown in FIG. 15 is allowed to include the identification ID, and is imaged by a video camera of the mobile phone to be automatically input to the display window 2001.

In Step S1303, the mobile phone login authentication program 3122P of the application server unit 312 searches the database 311 for the target television identification ID and the password of the sub-user for authentication.

In the case where the result of authentication shows that the input identification ID or password is not stored in the database 311 and it is determined as not authenticated (No in the flow diagram), the mobile phone HTML (3132H) generates an error display to be transmitted to the mobile phone 111 for display on the display unit 11101 in Step S1304, and displays the screen of FIG. 20 again in Step S1301 to wait for inputting of the identification ID and the password again.

The identification ID storing unit 311A2 storing the corresponding identification ID and the mobile phone login storing unit 311A3 storing the password are detected and it is determined as authenticated in Step S1303 (Yes in the flow diagram), the web server unit 313 transmits the HTML, generated on the basis of the mobile phone HTML (3132H) to the mobile phone in Step S1305, and displays the message board screen on the mobile phone. At this time, the mobile phone HTML (3132H) retrieves all pieces of message information for the target television identification ID, namely, the user name, input date, and message, stored in the database 311 via the application server 312, and generates the HTML to be transmitted to the mobile phone 111 for display on the display unit 11101. FIG. 21 is a diagram showing an example of a display screen at this time. The message stored in the message data 1 of the data storing unit 311A is displayed on the first message board 2101.

Since the mobile phone already logs in with the password and the television identification ID as described above, security may be improved as compared to, for example, a case in which the mobile phone is connected to the server device using the phone number or the like.

Next, an editing method of a message from the mobile phone will be described. The sub-user selects and determines a board to be edited from a message board screen shown in FIG. 21 in Step S1306. In the case where a board is not selected for a predetermined period (No in the flow diagram), the flow is completed without performing any other steps. When a board is selected (Yes in the flow diagram), editing work may be started. It is conceivable that the input message 2101 from the television is overwritten. However, there will be herein described a case in which a second message board 2102 different from the first message board 2101 is selected with the key operation unit 11108. In response to this, the mobile phone HTML (3132H) of the web server unit 313 transmits the message editing screen to the mobile phone 111 to be displayed on the display unit 11101 in Step S1307. An example of a display screen is shown in FIG. 22. An input screen for the message board 2 is displayed.

In the case where the user does not input a message for a predetermined period in Step S1308 (No in the flow diagram), it is determined that the message is not to be edited, and the message board screen as shown in FIG. 21 is displayed again in Step S1310. In the case where the message is to be edited (Yes in the flow diagram), the sub-user performs text edition at an editing area 2201 of the editing screen from the key operation unit 11108.

An example of a display screen at this time is shown in FIG. 23. When pushing a pushing button 2302 for transmission after newly writing a message 2301, the edited message information is stored into a target portion of the database 311, namely, the message data 2 of the data storing unit 311A in FIG. 2 via the message board program 3123P of the application server unit 312. At this time, the input sub-user name and the date indicated by the clock unit 3126 of the application server unit 312 are similarly stored into the message data 2.

After storage, the screen of the mobile phone is shifted to the message board screen in Step S1310. At this time, the latest message information is read from the message data storing unit 311A1 via the application server unit 312, and is displayed in an HTML format generated on the basis of the mobile phone HTML (3132H). Therefore, in addition to a newly-produced message 2403, a newly-stored date 2401 and an input sub-user name 2402 are added to the message board screen of FIG. 21, and are displayed as shown in FIG. 24.

Display on the television after the message is edited from the mobile phone as described above is shown in FIG. 25. In this case, the television HTML (3131H) of the web server 313 is accessed from the television A (110) to retrieve the latest information from the database 311 via the message board program 3123P of the application server unit 312, and the HTML generated on the basis of the television HTML (3131H) is received to be displayed on the display unit 11001 of the television A (110). Therefore, a latest message 2503 is displayed on the second message board in the message board together with a newly-input sub-user name 2501 and a date 2502 as shown in FIG. 25. It should be noted that the television HTML also displays a message on each message board in accordance with the number of the message board, so that time-series messages may be displayed. Accordingly, it is possible to realize a bulletin board system through which messages may be exchanged between a user at home who uses the television and a sub-user being away from home who uses the mobile phone.

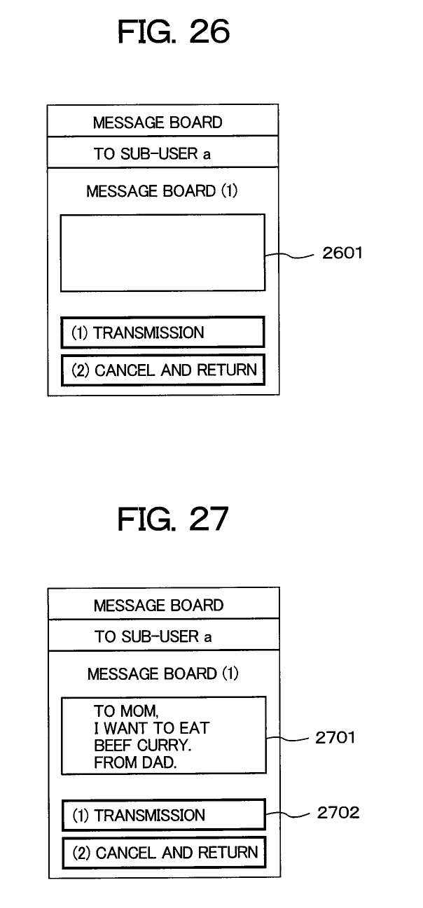

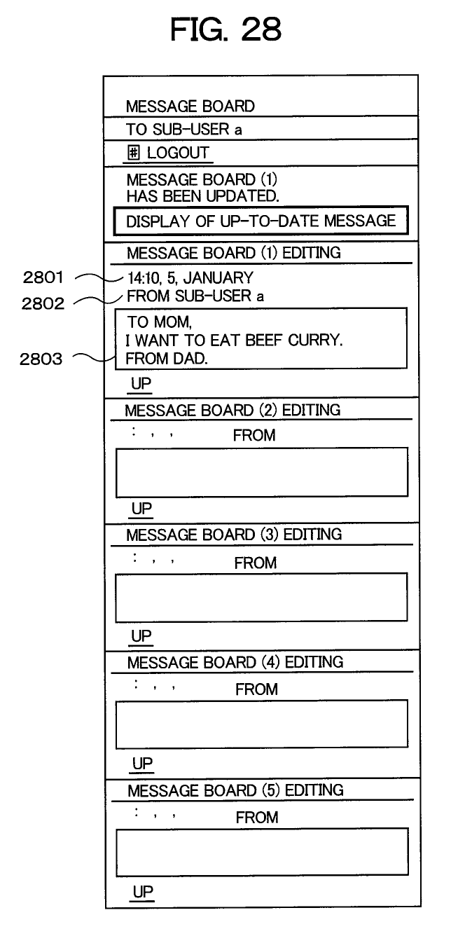

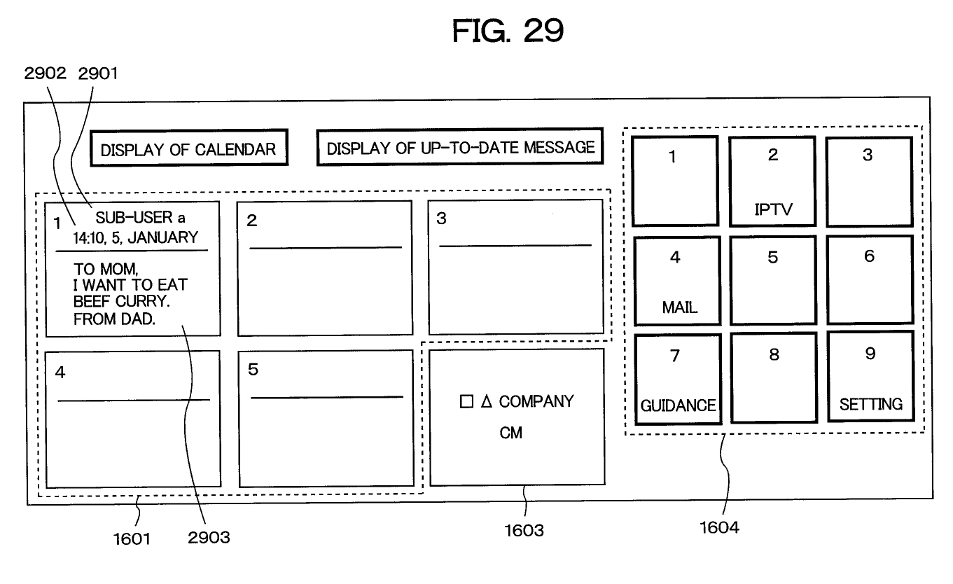

Next, an embodiment different from that shown in FIGS. 20 to 25 will be described using FIGS. 26 to 29. FIG. 26 is a diagram showing a screen of message editing of the mobile phone device according to another embodiment. FIG. 27 is a diagram showing a screen after message editing of the mobile phone device according to another embodiment. FIG. 28 is a diagram showing a screen after message board editing of the mobile phone device according to another embodiment. FIG. 29 is a diagram showing a screen of the message board of the television device after message board editing of the mobile phone device according to another embodiment.

There will be described a case in which when selecting and determining a board to be edited by a sub-user from the message board screen shown in FIG. 21 in Step S1306 of FIG. 13, selection is made with the key operation unit 11108 so as to overwrite the message 2101 input from the television. In response to this, the mobile phone HTML (3132H) of the web server unit 313 transmits the message editing screen to the mobile phone 111 to be displayed on the display unit 11101. An example of a display screen is shown in FIG. 26. Unlike FIG. 22, an input screen for the message board 1 is displayed.

In the case where the user does not input a message for a predetermined period in Step S1308 (No in the flow diagram), it is determined that the message is not to be edited, and the message board screen as shown in FIG. 21 is displayed again in Step S1310. In the case where the message is to be edited (Yes in the flow diagram), the sub-user performs text edition at the editing area 2601 of the editing screen from the key operation unit 11108. An example of a display screen at this time is shown in FIG. 27. When pushing a pushing button 2702 for transmission after newly writing a message 2701, the edited message information is stored into a target portion of the database 311, namely, the message data 1 of the data storing unit 311A in FIG. 2 via the message board program 3123P of the application server unit 312 in Step S1309. At this time, the input sub-user name and the date indicated by the clock unit 3126 of the application server unit 312 are similarly stored into the message data 1. In this case, both of the information previously input from the television and the information newly input from the mobile phone are stored, as the message information 1 shown in FIG. 4C, into the message data storing unit 311 of the server device 31.

After storage, the screen of the mobile phone is shifted to the message board screen in Step S1310. At this time, the latest message information is read via the application server unit 312, and is displayed in an HTML format generated on the basis of the mobile phone HTML (3132H). Therefore, as shown in FIG. 28, a newly-produced message 2803 is displayed on the message board 1, and the stored date 2401, and the input sub-user name 2402 are newly rewritten and displayed. That is, the display is different from the case of FIG. 24 in which the message is input to the message board 2.

Display on the television after the message is edited from the mobile phone as described above is shown in FIG. 29. In this case, the television HTML (3131H) of the web server 313 is accessed from the television A (110) to retrieve the latest information from the database 311 via the message board program 3123P of the application server unit 312, and the HTML generated on the basis of the television HTML (3131H) is received to be displayed on the display unit 11001 of the television A (110). Therefore, the message of the first message board of FIG. 19 is rewritten into a latest message 2903 for display as shown in FIG. 29, and a newly-input sub-user name 2901 and a date 2902 are also newly displayed after being rewritten. Accordingly, when sending a return message for the already-written message, the same message board is used, and thus, effective use may be made.

It should be noted that if the message that is already written on the message board 1 is displayed on the input screen of FIG. 26 and the sub-user adds a message to this as needed, it is possible to save past logs. If it is not necessary to save the past logs at this time, the sub-user may delete this to overwrite.

As described above, the message information is managed by the server device 31, together with the password of the sub-user shown in FIG. 4B and FIG. 15 and the input date with the user name including the television or the sub-user name. These pieces of information are stored into the message data storing unit 311A1 of FIG. 2, so that when the message is rewritten, the input date and the user name are also rewritten and displayed on the display units 11001 and 11101. One feature of the embodiment is that the identification ID of the television and the password of the mobile phone corresponding to the identification ID are detected by the server device 31 to recognize the login user name and the display of the user name is rewritten.

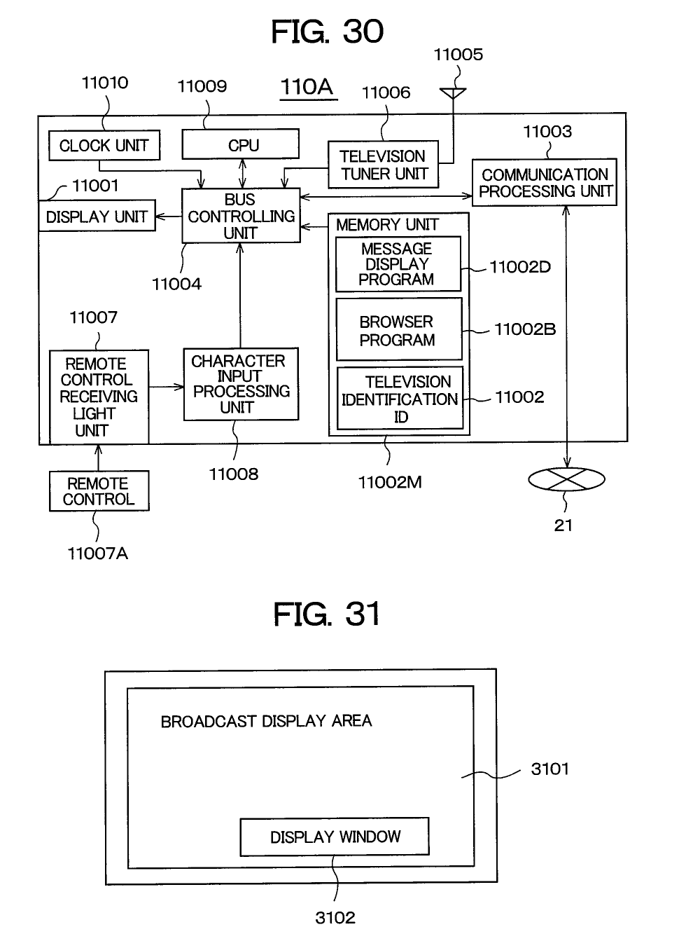

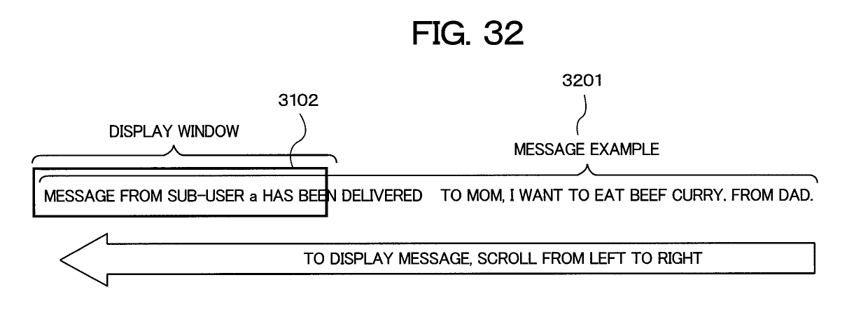

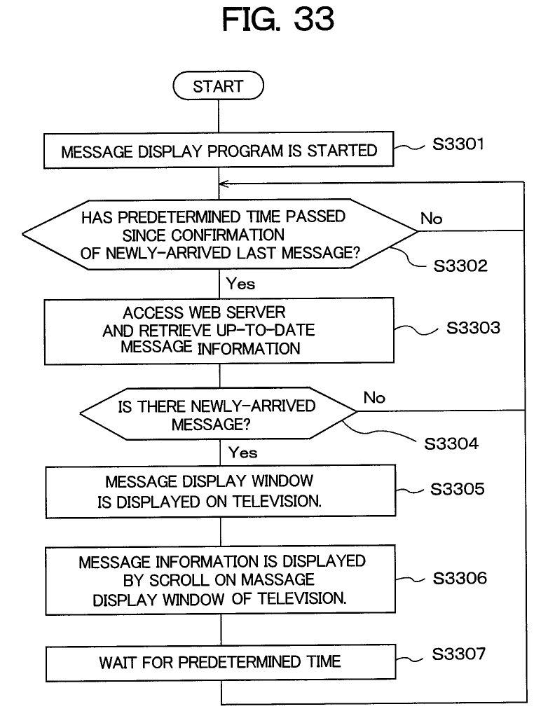

Next, still another embodiment will be described using FIGS. 30 to 33. FIG. 30 is a block diagram of the television device. FIG. 31 is a diagram showing a display screen of the television device. FIG. 32 is a diagram showing a display method of the television device. FIG. 33 is a flow diagram of a display process of the television device.

A television (110A) of FIG. 30 is different from the television 110 of FIG. 5 in that a message display program 11002D is added. The message display program 11002D may be one by which character information and the like are displayed using, for example, subtitles by a scheme called as an OSD (On Screen Display) on the display unit of the television. As compared to the television HTML incorporated in the server device 31, it is possible to configure with simple units, resulting in less risk of increasing the cost of the television.

The setting or the like when connecting to the server device 31 is the same as that of the television (110) of FIG. 5, and thus, explanation thereof will be not be repeated. In the case of FIG. 30, the message display program 11002D is being started during the operation of the television, and accesses the television HTML (3131H) of the web server unit 313 every time a predetermined time measured by the clock unit 11010 of the television (110A) passes. Then, the message display program 11002D reads the message information from the database 311 via the message board program 3123P of the application server unit 312. The message display program 11002D compares the date included in the read message information with that of the last access. In the case where there is a message newer than that on the date of the last access, the message is displayed as the latest message information by providing a display window for the message such as the OSD display at a part of a broadcasting video on the television side.

A display mode in this case will be described using FIGS. 31 and 32. The whole screen is usually used as a broadcast display area 3101, and a broadcast program according to a received broadcast is displayed. In the case where a message of a new date is detected, a display window 3102 for the message is provided at a part thereof. In the case where the whole message as a message example 3201 is not fitted into the display window 3102 as shown in FIG. 32, the whole message is displayed by scrolling the characters from the right to the left. The size of the display window 3102 is limited, and thus, only the latest message information may be displayed.

As described above, it is possible to automatically display a newly-arrived message at every predetermined time, and it is advantageous in reducing a time required for information transmission. It is obvious that even in the case of using the screen shown in FIG. 25 or the like, there may be employed a method of automatically displaying a message every time a new message is stored. However, there is a problem that the whole screen is suddenly switched to the display of the bulletin board during viewing of a program. Therefore, a program being broadcasted may be displayed in an OSD manner at a part of the screen of FIG. 25.

Further, it is common to read the message information itself from the server device 31. However, there is a difference in that the display screen shown in FIG. 31 or FIG. 32 is generated by the message display program 11002D incorporated in the television, whereas the display screen shown in FIG. 25 is generated by the television HTML (3131H) incorporated in the server device 31. However, the television involves less cost-related problem.

Next, an operation flow will be described using FIG. 33. When the television is started, the message display program 11002D incorporated in the television is started in Step S3301. In Step S3302, the message display program 11002D determines whether or not a predetermined time has passed since the confirmation of the previous newly-arrived message on the basis of passage of a time indicated by the clock unit 11010 of the television. In the case where the result of determination in Step S3302 shows that the predetermined time has not passed yet (No in the flow diagram), Step S3302 is performed again. In the case where the predetermined time has passed (Yes in the flow diagram), the message display program 11002D accesses the web server unit 313 to start to obtain the latest message information in Step S3303.

In Step S3304, the message display program 11002D determines whether or not there is a newly-arrived message after the last access by referring to the input date stored together with the message. In the case where there is no newly-arrived message (No in the flow diagram), the flow returns to Step S3302. In the case where there is a newly-arrived message (Yes in the flow diagram), the message display program 11002D displays the message display window 3102, as being exemplified in FIG. 31, on the television in Step S3305. Further, if the message is not fitted into the window 3102, the scroll display as being exemplified in FIG. 32 is performed in Step S3306 so as to display the whole message. Then, the flow returns to Step S3302 after waiting for a predetermined time in Step S3307. The operation is continued up to when the operation of the television is completed by, for example, turning off the power source.

A plurality of embodiments is described above. However, the above-described embodiments are illustrative only, and the present invention is not limited to those. A plurality of embodiments to which various modifications are added are possible, and they fall within the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A bulletin board system comprising:
a television device which is connected to a network and includes an identification ID storing unit which stores an identification ID for identifying a device, a first character information inputting unit which accepts inputting of character information, a first communication processing unit which transmits the character information and the identification ID to the network and receives information from the network, and a first display unit which displays the information received from the network;
a mobile information terminal device which is connected to the network and includes a second character information inputting unit which accepts inputting of character information, a second communication processing unit which transmits the character information to the network and receives information from the network, and a second display unit which displays the information received from the network; and
a server device which is connected to the network and includes a database storing unit which stores information, an application server unit which has a function of identifying the television device on the basis of the identification ID transmitted from the television device to determine whether or not to connect the television device, a login function for an access from the mobile information terminal device, and a function of reading or writing the information from/to the database storing unit, a web server unit which stores an HTML to be used for video display of the information on the first display unit by the television device and an HTML to be used for video display of the information on the second display unit by the mobile information terminal device, and generates an HTML of the information read by the application server unit on the basis of the stored HTML, and a third communication processing unit which transmits the HTML of the information generated by the web server unit to the network and receives information from the network, wherein
in the case where connection of the television device to the server device is authenticated by the application server unit of the server device, the information received from the network is displayed on the first display unit, and in the case where login of the mobile information terminal device is authenticated in the application server unit of the server device, the information received from the network is displayed on the second display unit.

2. The bulletin board system according to claim 1, wherein
a plurality of passwords are given for the identification ID of the television device, one of the plurality of passwords is given to the mobile information terminal device, and the mobile information terminal device logs in the application server unit of the server device on the basis of the password.

3. The bulletin board system according to claim 1, wherein
all pieces of information related to the identification ID of the television device are displayed on the first display unit of the television device and the second display unit of the mobile information terminal device.

4. The bulletin board system according to claim 1, wherein
in the case where the information related to the identification ID of the television device stored in the database storing unit of the server device is updated, notification of the update is displayed on the first display unit of the television device and the second display unit of the mobile information terminal device.

5. The bulletin board system according to claim 1, wherein
the application server unit of the server device reads or writes the information from/to the database storing unit on the basis of the received identification ID.

6. The bulletin board system according to claim 2, wherein
the application server unit of the server device reads or writes the information from/to the database storing unit on the basis of the received password.

7. A terminal device of a bulletin board system for exchanging information among a plurality of users, the device being connected to a server device storing information via a network and comprising:
an identification ID storing unit which stores an identification ID for identifying a device;
a character information inputting unit which accepts inputting of character information by a user;
a communication processing unit which transmits the character information and the identification ID to the network and receives information from the network; and
a display unit which displays the information received from the network, wherein
information related to the transmitted identification ID is received from the server device to be displayed on the display unit.

8. The terminal device of a bulletin board system according to claim 7, wherein
in the case where the information related to the identification ID of the television device stored in a database storing unit of the server device is updated, notification of the update is displayed on the display unit.

9. A server device of a bulletin board system for exchanging information among a plurality of users, the device being connected to a network and comprising:
a database storing unit which stores information;
an application server unit which has a function of determining whether or not to accept an access of a device on the basis of an identification ID of the device transmitted from the device connected via the network, and a function of reading or updating the information from the database storing unit;
a web server unit which stores an HTML to be used for video display of the information by the device connected via the network, and generates an HTML of the information read by the application server unit on the basis of the stored HTML; and
a communication processing unit which transmits the HTML of the information generated by the web server unit to the network, and receives information from the network, wherein
the HTML of the information related to the identification ID transmitted from the device connected via the network is transmitted to the network.
